(19) United States
(12) Patent Application Publication
(10) Pub. No.: US 2003/0035203 A1
(43) Pub. Date: Feb. 20, 2003

(54) Method and apparatus for dynamic optical gain tilting in L-band

(75) Inventors: Alex Shlifer, Rehovot (IL); Uri Ghera, Tel Aviv (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: REDC OPTICAL NETWORKS LTD.

(21) Appl. No.: 09/972,247

(22) Filed: Oct. 9, 2001

Related U.S. Application Data
(60) Provisional application No. 60/310,865, filed on Aug. 9, 2001.

(51) Int. Cl. H01S 3/00

(52) U.S. Cl. 359/337.1

(57) ABSTRACT

A method and apparatus for dynamically obtaining a substantially linear gain tilting of the output spectrum of an EDFA, in either automatic gain control or automatic power control modes. A necessary tilt is obtained while holding the total gain or total output power of the EDFA constant. The apparatus includes a variable mid-stage attenuator inserted between two (first and second) gain sections of the EDFA. The tilting is performed by ordering the attenuator to increase or decrease its attenuation in a value proportional to the tilting needed, while changing substantially simultaneously the pumping of the second gain section. The attenuation change process is based on the saturation mechanism of the erbium amplifier in the L-band, which translates the wavelength-independent loss of a variable optical attenuator into a linear wavelength-dependent gain at the EDFA output. The attenuation and pumping changes are preferably performed according to tables and functions contained in a management unit connected to the EDFA.

### CROSS REFERENCE TO RELATED APPLICATIONS

The present application claims the benefit of priority from U.S. Provisional Application No. 60/310,865 filed August 9, 2001, the contents of which are incorporated herein by reference.

### FIELD AND BACKGROUND OF THE INVENTION

This invention relates to the field of optical communications and erbium-doped fiber amplifiers (EDFAs), and in particular to performing dynamic gain tilting in EDFAs over the L-band (1570-1620 nm),

EDFAs are widely used in Wavelength Division Multiplexing (WDM) optical fiber communication systems as means to increase the distance of data transmission. For proper operation of such systems, optical signals at different wavelengths should have similar power at the EDFA output [E. Desurvire, Erbium-Doped Fiber Amplifiers. Principles and Applications, John Wiley, New York, 1994, p. 480]. However the inherent gain spectrum of the Erbium fiber is not flat, and thus different wavelengths will exit the EDYA with different powers [C. R. Giles and D. Di Giovanni, IEEE Photonics Technology Letters, vol. 2, No. 11 pp. 797-800, 1990]. To solve this problem, gain flattening filters are widely used in Er-doped fiber amplifiers [P. F. Wysocki et. al., IEEE Photonics Technology Letters vol. 9, No. 10, pp. 1343-1345, 1997; A. M. Vengsarker, in Proc. OFC'96, vol. 2, pp. 269-270, 1996; U.S. Pat. No. 5,900,969 to Srivastava et al.; U.S. Pat. No. 6,215,581 to Yadlowsky; U.S. Pat. No. 6,215584 to Yang. et al.; and U.S. Pat. No. 6,236,498 to Freeman et al.].

When links between amplifiers are short and overall power in the line is low, gain flattening is sufficient to obtain required network performance [P. C. Becker, N. A. Olsson, J. R. Simpson, Erbium-Doped Fiber Amplifiers. Fundamentals and Technology Academic Press, San Diego, 1999, p. 285]. Moreover, if link length, number of wavelengths and power budget are pre-determined, it is possible to insert a passive filter to correct wavelength dependent losses, which the link inflicts. However, in many cases the length and type of optical fibers used for the transmission between two fiber amplifiers is unknown before installation of the EDFA, and thus the wavelength-dependent loss of the link cannot be known beforehand. Furthermore, when several powerful signals propagate through the optical fiber, nonlinear effects are generated. The dominant nonlinear effect regarding tilting of the spectrum is Raman scattering [S. Bigo et al., IEEE Photonics Technology Letters, vol. 11, No. 6, pp. 671-673, 1999]. The Raman phenomenon leads to additional absorption of signals at longer wavelengths, effectively enhancing the power losses at these longer wavelengths.

To overcome those mechanisms of wavelength dependent loss/gain which are related to the link, it is desirable to perform dynamic gain tilting of the EDFA to pre-compensate (or post-compensate) link penalty. If such wavelength-dependent loss exists after system installation or reconfiguration, it should be possible to tilt the gain spectrum of the EDFA in order to achieve optimal network performance (best power equalization).

Various attempts have been made to provide dynamic gain tilting in EDFAs used in the L-Band. For example, tilters based on dynamic filters were proposed by T. Huang et al., in Proc. OFC'2001, Postdeadline Papers, paper PD29, 1996, and by Sumitomo Electric (VASC—Variable Attenuation Slope Compensator). However, use of these devices requires optical spectrum monitoring and analysis of incoming and outgoing optical signals, in order to control the transmission functions of the devices. Such optical spectrum monitoring complicates the tilting procedure and makes it very expensive. In addition, application of such filters implies separate control and monitoring of two gain sections (or two amplification processes) before and after the tilter.

There is thus a widely recognized need for, and it would be highly advantageous to have, a method for dynamic gain tilting in L-band EDFA that does not suffer from the disadvantages listed above. That is, in order to optimize network performance, an optical amplifier should have the possibility to regulate the tilt of its output optical spectrum, while holding the total signals power or gain consant.

### SUMMARY OF THE INVENTION

The present invention is of a method for dynamic gain tilting in L-band EDFA. More specifically, the method for dynamic gain tilting in L-band EDFA of the present invention simplifies and reduces the cost of the operation of a necessary tilt control. These advantages are achieved due to the fact that the method of the present invention assumes neither optical spectrum monitoring nor separate monitoring of the two optical gain sections (before and after the tilt adjustment section). Tilting of the output spectrum of the EDFA can be achieved by implementing the proposed method both in automatic gain control (AGC) and automatic power control (APC) operating modes of an EDFA optical amplifier in the L Band.

The apparatus includes a first section of an EFDA in which optical signals are preamplified. This section is pumped at a constant pumping power, which does not change due to a change in the tilt. Signals exiting this section pass through variable attenuation unit that includes a variable optical attenuator (VOA) and, optionally, a passive filter such as a gain flattening filter, and then are further amplified in a second section of the EDFA in which the pump level depends on the working conditions of the EDFA. The tilting functionality, combined with keeping Gain or Power of the EDFA constant, is achieved by a joint operation of change of the attenuation level of the VOA and the pump power of the second section.

According to the present invention there is provided a method for dynamic optical gain tilting in an optical amplifier operating in the L-band, the method comprising: a) providing an optical fiber amplifier having a first gain section and a second gain section; b) providing a mid-stage variable optical attenuator, the attenuator connected between the first and second gain sections; and c) controlling substantially simultaneously the attenuation in the mid-stage attenuator and the gain in the second gain section, whereby a substantially linear gain tilting of the optical amplifier is achieved over the L-band while keeping the total gain constant.

According to the present invention there is provided a method for gain tilting in a dual-stage erbium-doped fiber amplifier having a first gain section and a second gain section, comprising: a) providing a mid-stage variable optical attenuator connected between the first mid second gain sections: and b). using the mid-stage attenuator and the second gain section to obtain a gain tilt for the erbium-doped fiber amplifier over a wide spectral range, while keeping an output parameter of the amplifier constant.

According to the present invention there is provided an apparatus for optical dynamic gain tilting in the L-band, the apparatus comprising: a) a dual-stage optical fiber amplifier having a first and a second gain section; b) a variable optical attenuator connected therebetween the first and second gain sections; and c) a management unit used for controlling the attenuator and the second gain sections and for obtaining a gain tilt output for the amplifier, the controlling and obtaining steps being related to amplifier parameters fed to the management unit, whereby a substantially linear dynamic gain tilting is achieved over the L-band while keeping an output parameter of the amplifier constant.

### BRIEF DESCRIPTION OF THE DRAWINGS

The invention is herein described, by way of example only, with reference to the accompanying drawings, wherein:

FIG. 1 is a schematic description of a dual-stage optical fiber amplifier having the ability of dynamic gain tilting;

FIG. 2 illustrates ideal and experimentally achieved 1-dB tilts;

FIG. 3 is a schematic description of a preferred embodiment of the method of the present invention;

FIG. 4 shows: (a) spectrum of an EDFA without tilting, (b) a spectrum with a 1-dB tilt using a preferred embodiment of the method and apparatus of the present invention, and (c) a spectrum with a 3-dB tilt using a preferred embodiment of the method and apparatus of the present invention,

### DESCRIPTION OF THE PREFERRED EMBODIMENTS

The present invention is of a method for dynamic gain tilting in L-band EDFA. Specifically, the present invention can be used to compensate for wavelength dependent loss (or gain) along the transmission line.

The principles and operation of a method for dynamic gain tilting in L-band EDFA according to the present invention may be better understood with reference to the drawings and the accompanying description.

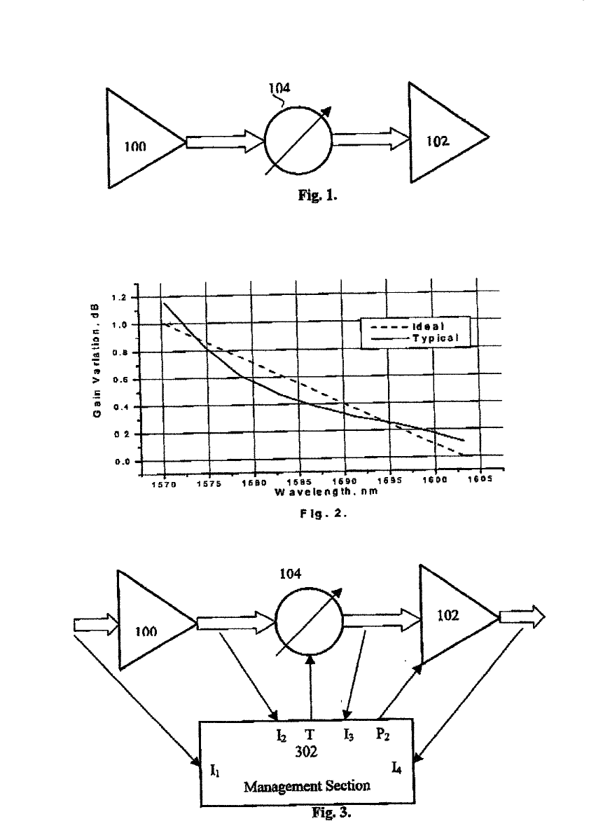

Referring now to the drawings, FIG. 1 illustrates a preferred embodiment of an optical fiber amplifier having the ability to realize dynamic gain according to the present invention. The device has two gain sections, a first gain section or stage 100 and a second gain section or stage 102, separated by a mid-stage section 104 that is capable of changeable or adjustable attenuation. Devices with more than two stages (e.g. multi-stage fiber amplifiers) are possible and fall within the scope of the present invention Mid-stage section 104 may include passive devices with wavelength-dependent attenuation (e.g. a gain-flattened filter or a Dispersion Compensating Fiber) in addition to a variable attenuation unit with wavelength-independent attenuation. To generally portray the tilting effect of the proposed method, N optical signals at different wavelengths λᵢ (i=1 . . . N) at the input of the device are considered. Each signal is amplified in the gain sections 100 and 102, and attenuated in the mid-stage section 104. Due to the properties of the Er-doped fibers and principles of laser amplification, the gain of each signal (for each gain section) depends on the wavelength of this signal, and can be expressed approximately as follows [C. R. Giles, Journal of Lightwave Technology, vol. 9, No. 2, pp. 271-283, 1991]:

$${G}_{ij} = 4.3431 {l}_{j} [ \{ {g}^{*} ( {λ}_{ij} ) + α ( {λ}_{ij} ) \} \frac{{N}_{1 j}}{{N}_{j}} - α ( {λ}_{ij} ) ]$$

where j is the number of the gain section (j=1, 2), Gᵢⱼ is the gain (in dB) of the j^{th} gain section at an i^{th} wavelength, lⱼ is the length of the Er-doped fiber, N₁ⱼ is the number of excited (situated at upper energetic level) Er-ions and Nⱼ is the total number of Er-ions in the j^{th}_section, and g*(λᵢⱼ) and α(λᵢⱼ) are gain and loss (in dB/m) of j^{th} Er-doped fiber at i^{th} wavelength (g*(λᵢⱼ) and α(λᵢⱼ) are also known as Giles parameters). Note that N₁ⱼ depends on the total optical power (defined mainly by the pump power, and less by the signals power), while Nⱼ is constant for the defined fiber.

At mid-stage section, signals attenuation can be expressed as:

Lᵢ=L(λᵢ)A (2)

where L(λᵢ) is the wavelength-depended attenuation of any passive devices located at mid-stage (for example of a gain-flattened filter or a Dispersion Compensating Fiber), and A is the wavelength-independent attenuation of the variable attenuation unit.

Before a variable attenuation element is adjusted to reach required tilt, a flattened gain spectrum is obtained at the output. For each λ, total gain will be equal to

$${G}_{i} = \frac{{G}_{i1} {G}_{i2}}{{L}_{i} A} = \frac{{G}_{i1} {G}_{i2}}{L ( {λ}_{i} ) A} = G ( 0 ) \qquad ( 3 )$$

If the mid-stage attenuation A is now changed, the optical power entering into second gain section 102 will be changed, so it is necessary to change the total gain (defined as the difference (in dBm) between total output signals power and total input signals power) of one (or both) of the gain sections, to hold the total gain of all device constant. To reach such total gain variation for the j^{th} gain section, the optical pump power of that section should be changed. As a result, the N₁ⱼ value is changed to some new value Ñ₁ⱼ. According to the present invention, in a dual-stage amplifier, such a procedure should be taken only for second stage 102 to avoid any control of first stage 100.

In the following example, which is given in order to clarify the physics of the tilting process, it is assumed that a gain change in the second stage is performed in response to an attenuation increase. After increasing the attenuation, in order to keep the overall gain constant, the gain of second gain section 102 behaves according to eq. 1. The gain of the i^{th} wavelength in this section will be changed by

$$Δ {G}_{i2} = 4.343 {l}_{j} \{ {g}^{*} ( {λ}_{ij} ) + α ( {λ}_{ij} ) \} \frac{{N}_{12} - {\tilde{N}}_{12}}{{N}_{2}} \qquad ( 4 )$$

where λ₁ is the shortest wavelength and the λ_{N} is the longest wavelength. Following eq. 4, one obtains:

$$\frac{Δ {G}_{12}}{Δ {G}_{N2}} = \frac{{g}^{*} ( {λ}_{12} ) + α ( {λ}_{12} )}{{g}^{*} ( {λ}_{N2} ) + α ( {λ}_{N2} )} = {ρ}_{1 N} \neq 1 \qquad ( 5 )$$

In this case the output spectrum is not flattened, and it has some tilt defined by ρ_{1N} which depends on the properties of the Er-doped fiber. For standard Er-doped fibers, ρ_{1N}>1 for any λ₁ and λ_{N} in the L-band, therefore the mid-stage attenuation A should be increased to increase the gain tilt. Such increasing of the attenuation A leads to a decreasing of signals at the input of the second stage, so the total gain of the second gain stage should be increased (with the help of corresponding pump power variation), to hold a constant total gain or total output power.

Normally, for any λᵢ in the range λ₁<λᵢ<λ_{N}, the value ρ_{iN} decreases monotonically with increasing wavelength. The variation of gain with wavelength, i.e. the function ΔG(λ) is not linear, however the deviation from the linear function is small enough in the range of L-band. FIG. 2 shows a typical experimental curve of a 1-dB tilt in comparison to a linear line. The tilt has a maximum deviation from linearity of about ±0.15 dB. FIG. 3 is a schematic description of a preferred embodiment of the method of the present invention. Both first gain section 100 and second gain section 102 have pump sections preferably controlled by an amplifier microprocessor (not shown) incorporated in a management unit 302. The mid-stage attenuator is also controlled by management unit 302, preferably through the microprocessor. The microprocessor receives data related to the total optical power of signals at the input and output of the EDFA-(I₁ and I₄, respectively) to calculate a total gain I₄/I₁. Additionally, the total optical power of signals at the input and output of the mid-stage (I₂ and I₃, respectively) can be used to measure and adjust the mid-stage attenuation I₂/I₃. Both levels of the attenuation and pump power are preferably taken from relevant tables and algorithms existing in the microprocessor memory. In addition, the microprocessor produces signals to control the pump or pumps of gain section 102, thus holding the total gain constant. It is necessary to note here that each of gain sections 100 and 102 can include more than one pump, more than one piece of fiber, etc. The variable optical attenuator may be inserted between any of the EDFA stages, in which case the stages preceding it belong to the “first gain section”, and the stages after it belong to the “second gain section” as referred to herein.

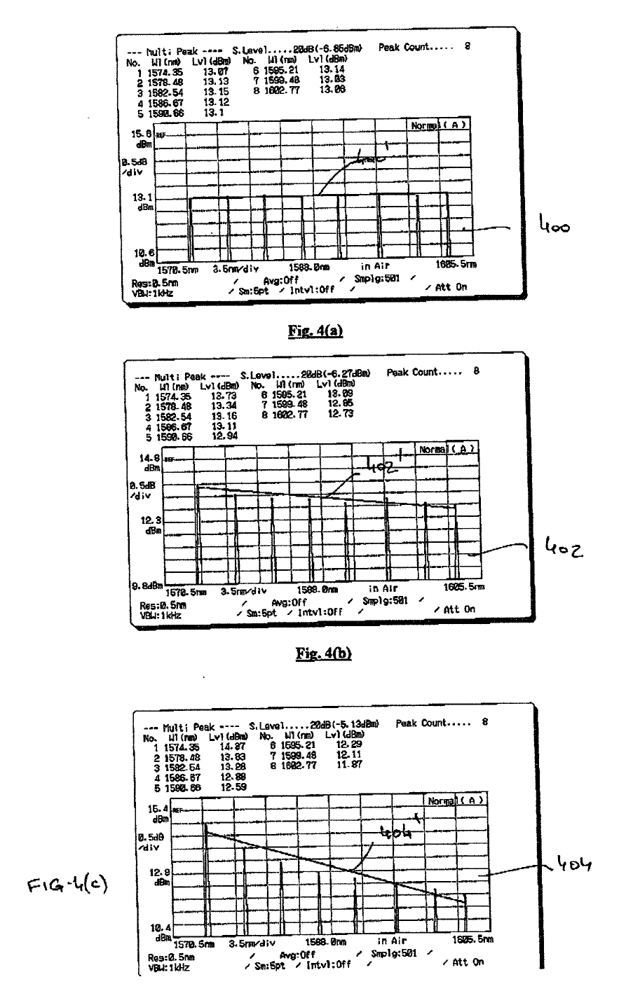

FIG. 4 illustrates experimental results, where differed tilt levels are obtained with the same dual-stage amplifier that has 8 input channels: a) initial flat output spectrum 400 (flatness=±0.07 dB): b) a 1-dB tilt spectrum 402 (maximum deviation from linearity of about ±25 dB); and c) a 3-dB tilt spectrum 404 (maximum deviation from linearity of about ±0.35 dB). For each spectrum solid lines 400′, 402′ and 404′ in (a), (b) and (c) respectively represent ideal tilt. For this amplifier, mid-stage attenuation was increased by ˜1.2 dB and pump power in the second stage was increased simultaneously by ˜3% to reach 1-db change of tilt; mid-stage attenuation was then additionally increased by ˜2.4 dB and pump power in the second stage was additionally increased simultaneously by ˜6% to reach 3-db change of tilt.

A typical operation procedure of the tilting is as follows: after a “tilt=T” command is received from the management unit, the management unit (microprocessor) changes substantially simultaneously the mid-stage attenuation of unit 104 and the output power of the pumping section of second gain section 102, the latter to compensate for the total gain variation induced by the variation of the mid-stage loss. As a result, the system continues to operate at the same total output gain (or/and total output powers), but having a required tilt of the output optical signals.

The method of the present invention can achieve substantially linear tilting of the output spectrum from the EDFA either in an AGC or an APC mode. The tilting is performed by ordering the attenuator to increase or decrease its attenuation in a value proportional to the tilting needed. This process is based on the saturation mechanism of the Erbium amplifier in the L-band, which translates the wavelength-independent loss of a variable optical attenuator into a linear wavelength-dependent gain at the EDFA output. In order to keep the gain (or power) of the amplifier constant, there is no need for power changes of the pump of the amplifier preceding the VOA (“first gain section”), and changes occur only at optical pumping of stages after the VOA (“second gain section”). Those changes are preferably performed according to tables and functions in the microprocesor of the EDFA. The method of the present invention allows reaching a necessary tilt while holding the total gain or total output power constant.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A method for dynamic optical gain tilting in an optical amplifier operating in the L-band, the method comprising:
a. providing an optical fiber amplifier having a first gain section and a second gain section;
b. providing a mid-stage variable optical attenuator, said attenuator connected between said first and second gain sections; and
c. controlling substantially simultaneously the attenuation in said mid-stage attenuator and the gain in said second gain section, whereby a substantially linear gain tilting of the optical amplifier over the L-band is achieved while keeping the total gain constant.

2. The method of claim 1, wherein said step of providing an optical fiber amplifier includes providing an erbium-doped fiber amplifier.

3. The method of claim 2, wherein said step of controlling further includes:
i. obtaining amplifier input and output information related respectively to optical signals entering said erbium-doped fiber amplifier at an amplifier input, and exiting said erbium-doped fiber amplifier at an amplifier output;
ii. obtaining mid-stage input and output information related respectively to optical signals entering said mid-stage attenuator from said first gain section and exiting said mid-stage attenuator to said second gain section; and
ii. processing said amplifier input and output information and said mid-stage input and output information, whereby said processing is used as input for said controlling.

4. The method of claim 3, wherein said substep of obtaining said amplifier input and output information includes measuring a total power of said optical signals entering and leaving said erbium-doped fiber amplifier respectively, and wherein said substep of obtaining said mid-stage input and output information includes measuring a total power of said optical signals entering and leaving said mid-stage attenuator respectively.

5. The method of claim 4, wherein said input includes instructions to change a pumping level of said second gain section.

6. The method of claim 5, wherein said input further includes instructions to change the attenuation of said mid-stage attenuator.

7. The method of claim 2, wherein said step of providing an optical fiber amplifier having a first gain section and a second gain section includes said amplifier having a first gain section that includes a first plurality of stages and a second gain section that includes a second plurality of stages.

8. A method for gain tilting in a dual-stage erbium-doped fiber amplifier having a first gain section and a second gain section, comprising:
a. providing a mid-stage variable optical attenuator connected between the first and second gain sections; and
b. using said mid-stage attenuator and the second gain section to obtain a gain tilt for the erbium-doped fiber amplifier over a wide spectral range, while keeping an output parameter of the amplifier constant.

9. The method of claim 8, wherein said substep of keeping said output parameter constant is preceded by selecting said output parameter from the group consisting of total signals power and total signals gain.

10. The method of claim 8, wherein said step of using said mid-stage attenuator and the second gain section to obtain said gain tilt further includes controlling substantially simultaneously the attenuation of said mid-stage attenuator and a pumping level of the second gain section.

11. The method of claim 10, wherein said substantially simultaneous control is based on a set of optical inputs.

12. The method of claim 11, wherein said optical inputs are selected from the group consisting of total amplifier input power and total amplifier output power.

13. The method of claim 12, wherein said optical inputs are further selected from the group consisting of total mid-stage optical input power and total mid-stage optical output power.

14. An apparatus for optical dynamic gain tilting in the L-band, the apparatus comprising:
a. a dual-stage optical fiber amplifier having a first gain section and a second gain section;
b. a variable optical attenuator connected therebetween said first and second gain sections;
c. a management unit used for controlling said attenuator and said second gain section and for obtaining a gain tilt output for said amplifier, said controlling and obtaining being related to amplifier parameters fed to said management unit, whereby a substantially linear dynamic gain tilting is achieved over the entire L-band while keeping an output parameter of said amplifier constant.

15. The apparatus of claim 14, wherein said amplifier is an erbium-doped fiber amplifier.

16. The apparatus of claim 15, wherein said erbium-doped fiber amplifier parameters fed into said management unit arm selected from the group consisting of total input amplifier power, total output amplifier power, total mid-stage input power and total mid-stage output power.

17. The apparatus of claim 15, wherein said output parameter is selected from the group consisting of total signals power and total signals gain.

18. The apparatus of claim 14, wherein said first gain section includes a first plurality of amplifier stages and wherein said second gain section includes a second plurality of amplifier stages.
